(19) United States
(12) Patent Application Publication
(10) Pub. No.: US 2021/0397301 A1
(43) Pub. Date: Dec. 23, 2021

(54) REDUCING CONNECTIONS FROM A SENSING MODULE ASSOCIATED WITH A DISPLAY DEVICE

(71) Applicant: Synaptics Incorporated, San Jose, CA (US)

(72) Inventor: Petr Shepelev, Campbell, CA (US)

(21) Appl. No.: 16/909,665

(22) Filed: Jun. 23, 2020

(51) Int. Cl. G06F 3/044; G06F 3/041

(52) U.S. Cl. CPC G06F 3/0445; G06F 2203/04102; G06F 3/04164; G06F 3/0412

(57) ABSTRACT

An input device includes a display substrate; a stack of display layers and at least one capacitive sensing layer disposed on the display substrate, the stack of display layers including display pixels of a display screen. The input device further includes capacitive sensing electrodes disposed in the at least one capacitive sensing layer and configured for capacitance sensing. The input device also includes a source driver circuit configured to drive at least a subset of the display pixels; a multiplexer (MUX) circuit coupled to sources and a sensing channel. The sources includes at least a subset of the sensing electrodes. The MUX circuit selectively couples one of the sources to the sensing channel based on a control signal. The input device also includes a semiconductor package enclosing the source driver circuit and the MUX circuit.

### TECHNICAL FIELD

The described embodiments relate generally to electronic devices, and more specifically, to the use of a multiplexer in the coupling of a sensing module to an integrated controller (IC) (e.g., touch IC) within an input device.

### BACKGROUND

Input devices including proximity sensor devices (e.g., touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones). Proximity sensor devices may be used to detect finger, styli, or pens.

These input devices often include sensing modules with many connections to ICs (e.g., touch ICs). These many connections are costly and occupy valuable space in the input device.

### SUMMARY

In general, in one aspect, one or more embodiments relate to an input device, comprising: a display substrate; a stack of display layers and at least one capacitive sensing layer disposed on the display substrate, the stack of display layers comprising a plurality of display pixels of a display screen; a plurality of capacitive sensing electrodes disposed in the at least one capacitive sensing layer and configured for capacitance sensing; a source driver circuit configured to drive at least a subset of the plurality of display pixels; a multiplexer (MUX) circuit coupled to a plurality of sources and a sensing channel, wherein the plurality of sources comprises at least a subset of the plurality of sensing electrodes, and wherein the MUX circuit selectively couples one of the plurality of sources to the sensing channel based on a control signal; and a semiconductor package enclosing the source driver circuit and the MUX circuit.

In general, in one aspect, one or more embodiments relate to a method for operating an input device, comprising: receiving, by a multiplexer (MUX) circuit, a control signal, wherein the MUX circuit is coupled to a sensing channel and a plurality of sources comprising a plurality of capacitive sensing electrodes, and wherein a semiconductor package encloses the MUX circuit and a source driver circuit, the source driver circuit configured to drive a plurality of display pixels of a display screen integrated in the input device; coupling, by the MUX circuit and based on at least the control signal, the sensing channel with a source of the plurality of sources; and relaying, by the MUX circuit, a resulting signal corresponding to capacitance sensing from the source to a touch integrated circuit (IC) coupled to the sensing channel.

In general, in one aspect, one or more embodiments relate to an interface module, comprising: a source driver circuit configured to drive a plurality of display pixels of a display screen; and a multiplexer (MUX) circuit configured to couple to a plurality of sources configured for capacitive sensing of the display screen and a sensing channel, wherein the MUX circuit selectively couples one of the plurality of sources to the sensing channel based on a control signal; and a semiconductor package enclosing the source driver circuit and the MUX circuit.

Other aspects of the embodiments will be apparent from the following description and the appended claims.

### BRIEF DESCRIPTION OF DRAWINGS

FIG. 1 shows a block diagram of an input device combined with a display device, in accordance with one or more embodiments.

FIG. 2A shows a block diagram of a sensing module in an input device combined with a display device in accordance with one or more embodiments.

FIG. 2B shows a block diagram of a sensing module in an input device combined with a display device in accordance with one or more embodiments.

FIG. 2C shows a block diagram of a sensing module in an input device in accordance with one or more embodiments.

FIG. 3 shows a semiconductor package, including a source driver circuit and a multiplexer circuit, in accordance with one or more embodiments.

FIG. 4 shows a flowchart in accordance with one or more embodiments.

FIG. 5 shows a flowchart in accordance with one or more embodiments.

### DETAILED DESCRIPTION

The following detailed description is merely exemplary in nature, and is not intended to limit the disclosed technology or the application and uses of the disclosed technology. Furthermore, there is no intention to be bound by any expressed or implied theory presented in the preceding technical field, background, or the following detailed description.

In the following detailed description of embodiments, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the present disclosure provide input devices and methods utilizing multiplexing/demultiplexing. The multiplexing/demultiplexing may reduce the number of traces required to interface with a combination of an input interface and a display screen (for example, a touch screen). The sensing electrodes of an input interface, further described below, may have numerous traces to convey electrical charges to a touch sensing interface, where the charges are measured for the purpose of detecting touch. The space available to accommodate traces to the touch sensing interface may be limited. Further, the combination of the input interface and the display screen may be flexible, e.g., in implementations that rely on flexible organic light-emitting diode (OLED) panels. In one or more embodiments, multiplexer (MUX) circuits are, thus, used to couple many sensing electrodes to fewer traces for interfacing to the touch sensing interface. As a result of the reduced number of traces, interfacing via a flexible printed circuit (or any other connector) that does not have sufficient space to accommodate all the traces prior to the reduction, may now be possible. In one or more embodiments, the MUX circuits are integrated with source driver circuits, configured to drive the pixels of the display screen in a single semiconductor package. The integration of a MUX circuit and a source driver circuit in a single semiconductor package may allow MUX circuits to be accommodated on a display substrate of the display screen or elsewhere, despite limited surface space.

The implementation of multiplexing schemes based on MUX circuits that share semiconductor packages with source driver circuits is subsequently discussed.

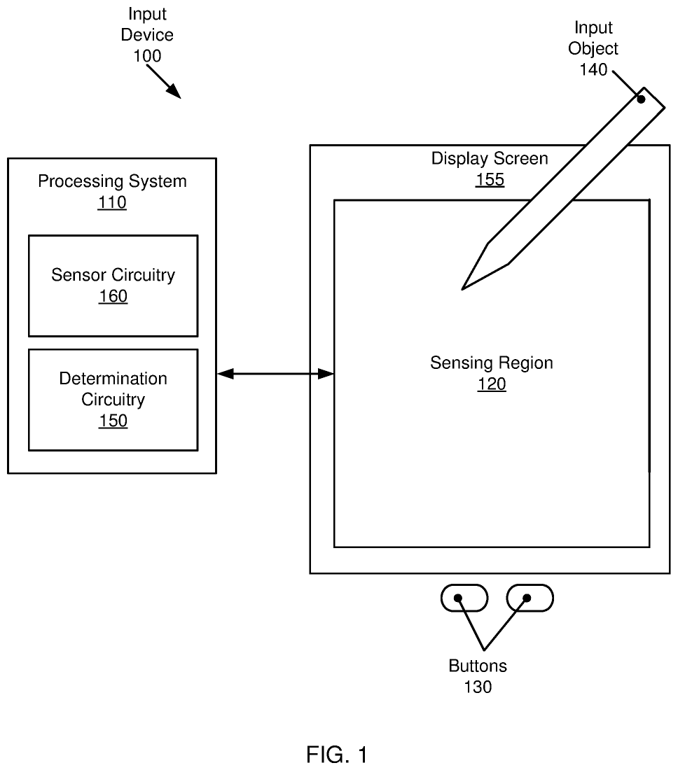

FIG. 1 is a block diagram of an example of an input device (100), in accordance with one or more embodiments. The input device (100) may be configured to provide input to an electronic system (not shown). As used in this document, the term “electronic system” (or “electronic device”) broadly refers to any system capable of electronically processing information. Some non-limiting examples of electronic systems include personal computers, such as desktop computers, laptop computers, netbook computers, tablets, web browsers, e-book readers, smart phones, and personal digital assistants (PDAs).

In FIG. 1, the input device (100) is shown as a proximity sensor device (e.g., “touchpad” or a “touch sensor device”) configured to sense input provided by one or more input objects (140) in a sensing region (120). Example input objects include styli, an active pen, and fingers. Further, which particular input objects are in the sensing region may change over the course of one or more gestures. For example, a first input object may be in the sensing region to perform the first gesture, subsequently, the first input object and a second input object may be in the above surface sensing region, and, finally, a third input object may perform the second gesture. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects). The sizes, shapes, and locations of particular sensing regions may vary widely from embodiment to embodiment.

The input device (100) may utilize any combination of sensor components and sensing technologies to detect user input in the sensing region (120). The input device (100) includes one or more sensing elements for detecting user input. As a non-limiting example, the input device (100) may use capacitive techniques.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitance sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may by a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”, TX) and one or more receiver sensor electrodes (also “receiver electrodes” or “receiver”, RX). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments, the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g. other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

In FIG. 1, a processing system (110) is shown as part of the input device (100). The processing system (110) is configured to operate the hardware of the input device (100) to detect input in the sensing region (120). The processing system (110) includes parts of or all of one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one or more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens (155), driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include determination circuitry (150) and a sensor circuitry (160). The determination circuitry (150) may include functionality to determine when at least one input object is in a sensing region, determine signal to noise ratio, determine positional information of an input object, identify a gesture, determine an action to perform based on the gesture, a combination of gestures or other information, and/or perform other operations. The determination circuitry (150) may include hardware and/or software which may execute on processor.

The sensor circuitry (160) may include functionality to drive the sensing elements to transmit transmitter signals and receive the resulting signals. For example, the sensor circuitry (160) may include sensory circuitry that is coupled to the sensing elements. The sensor circuitry (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows determination circuitry (150) and a sensor circuitry (160), alternative or additional modules may exist in accordance with one or more embodiments. Such alternative or additional modules may correspond to distinct modules or sub-modules than one or more of the modules discussed above. Example alternative or additional modules include hardware operation modules for operating hardware such as sensor electrodes and display screens (155), data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen (155). For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), microLED, liquid crystal display (LCD), or other display technology. The input device (100) and the display screen may share physical elements. For example, some embodiments may utilize some of the same electrical components for displaying and sensing. In various embodiments, one or more display electrodes of a display device may be configured for both display updating and input sensing. As another example, the display screen may be operated in part or in total by the processing system (110).

While FIG. 1 shows a configuration of components, other configurations may be used without departing from the scope of the invention. For example, various components may be combined to create a single component. As another example, the functionality performed by a single component may be performed by two or more components.

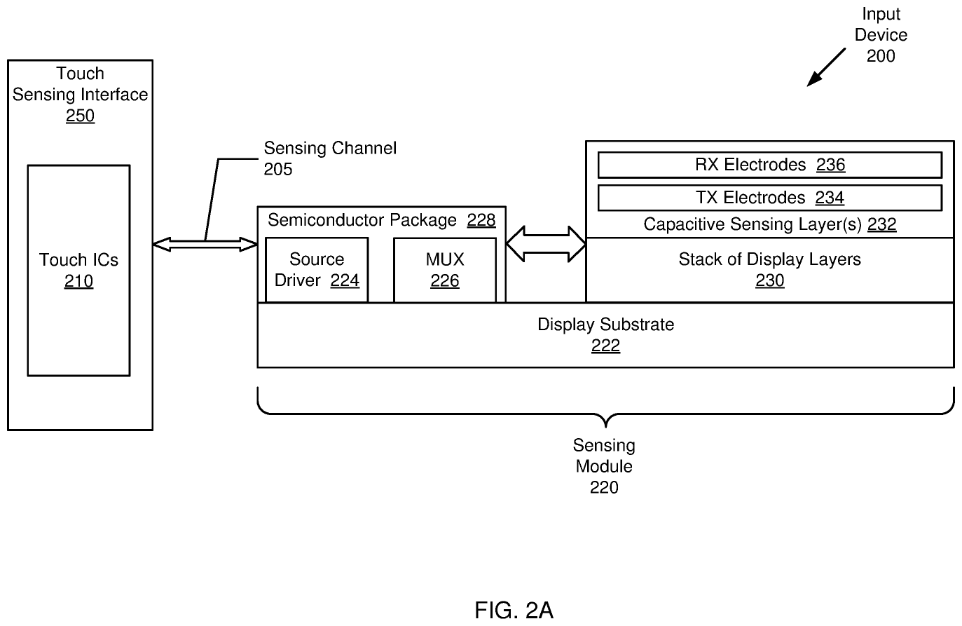

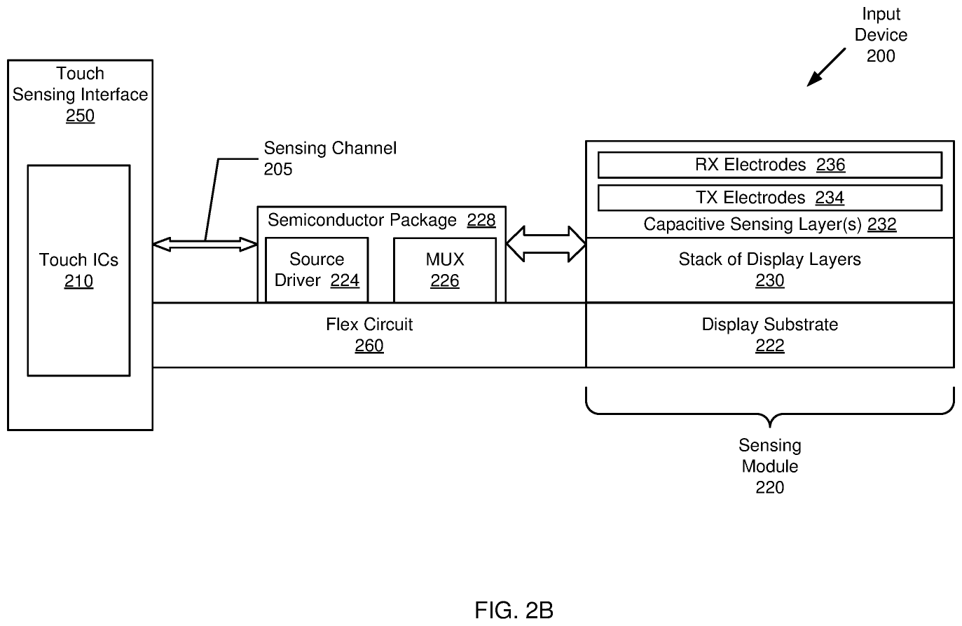

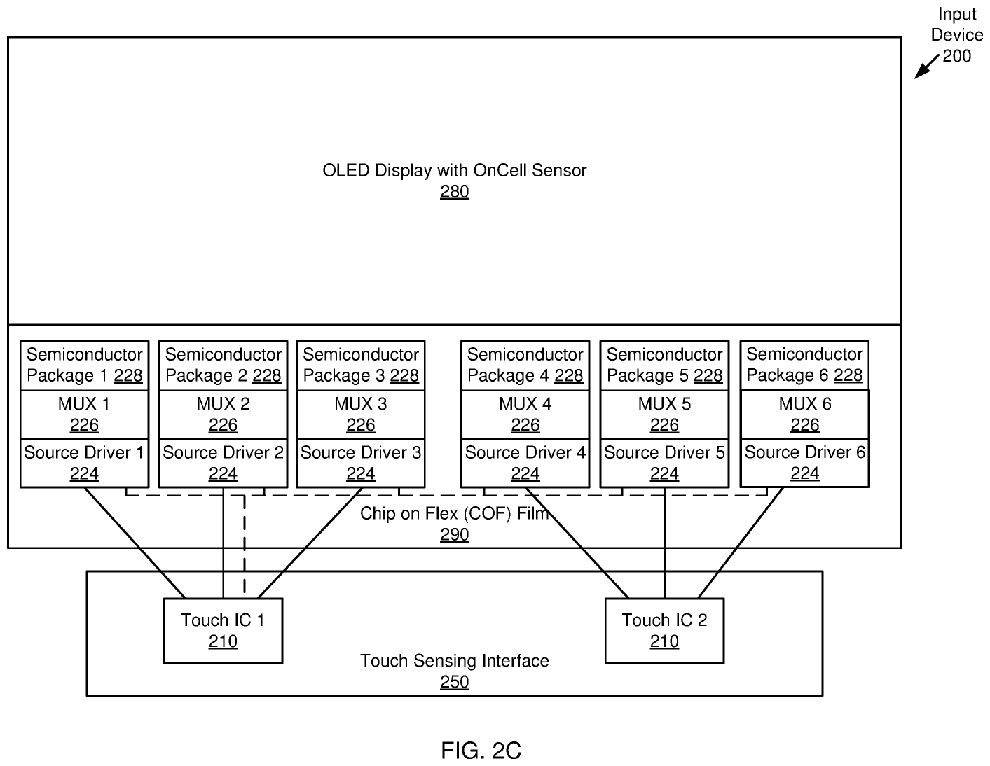

FIG. 2A shows an input device (200) in accordance with one or more embodiments. As shown in FIG. 2A, the input device (200) includes a sensing module (220) coupled to a touch sensing interface (250) via a sensing channel (205). The sensing module (220) may be used to implement all or a part of the sensing region (120), discussed above in reference to FIG. 1. The sensing module (220) may also be used to generate a display for all or part of the display screen (155), also discussed above in reference to FIG. 1. Further, the touch sensing interface (250) may include a touch integrated circuit (210), which may be a component of the processing system (110). For example, the touch integrated circuit (210) may be a component of the sensor circuitry (160) and/or the determination circuitry (150), discussed above in reference to FIG. 1.

In one or more embodiments, the sensing module (220) has multiple layers including a stack of display layers (230), and one or more capacitive sensing layers (232), and a display substrate (222). In one embodiment, the display screen is an OLED display. Accordingly, the stack of display layers (230) may include OLED display layers such as an organic emissive layer, an anode layer, a cathode layer, one or more conductive layers which may include a thin-film transistor (TFT) layer, etc. The stack of display layers (230) may be disposed on the display substrate (222). In one embodiment, the display substrate (222) is a flexible plastic substrate or another suitable flexible substrate, to enable a flexible, rollable and/or foldable OLED display.

The stack of display layers (230) may include microLED layers such as a layer of LEDs disposed on a thin-film transistor (TFT) layer on the display substrate (222).

The stack of display layers (230) may include LCD display layers such as a color filter glass layer, a liquid crystal layer, and a TFT layer disposed on the display substrate (222), which may be glass.

The sensing module (220) may have additional layers and components. In one or more embodiments, multiple transmitter (TX) (234) and/or receiver (RX) (236) electrodes are disposed in the one or more capacitive sensing layers (232). The TX (234) and/or RX (236) electrodes may be used in capacitance sensing (e.g., absolute capacitance sensing, mutual capacitance sensing, etc.). While in FIG. 2A, the capacitive sensing layer(s) (232) are shown in a location on top of the stack of display layers (230), those skilled in the art will appreciate that these layers may be located anywhere, relative to the stack of display layers (230). For example, one layer with RX electrodes (236) may be located on top of the stack of display layers (230), and another layer with TX electrodes (234) may be located in or below the stack of display layers (230). Alternatively, there may be no layer with TX electrodes. In one or more embodiments, the sensing module (220) includes a matrix pad sensor with numerous sensing pads and traces connecting to the sensing pads in a metal mesh layer across the sensing region. The matrix pad sensor may include at least one such metal mesh layer. Instead of using a dedicated metal mesh layer, a display layer, e.g., a OLED display cathode layer may be patterned to serve as a metal mesh layer.

In one or more embodiments, the TX electrodes (234) and the RX electrodes (236), together, implement mutual capacitance sensing. In other words, a waveform is driven onto the TX electrodes (234) and a resulting signal(s) is received from the RX electrodes (236). The resulting signal is a function of the waveform and change in capacitance between the TX electrodes and RX electrodes (234, 236) due to the presence of an input object.

In one or more embodiments, the RX electrodes (236) are operated to perform absolute capacitance sensing independent of the TX electrodes (234). In one or more embodiments, the transmitter electrodes (234) are operated to perform absolute capacitance sensing independent of the receiver electrodes (236).

In one or more embodiments, the stack of display layers (230) includes one or more layers, e.g., a thin-film transistor (TFT) layer, with source lines and gate lines and transistors for controlling the individual OLED, LCD or microLED units of the pixels of the display screen. In one or more embodiments, one or more source lines and/or one or more gate lines are also operated to perform absolute capacitance sensing.

In one or more embodiments, a source driver circuit (224) drives the transistors that control the pixels of the display screen. Each of the pixels may be an OLED pixel, a microLED pixel, an LCD pixel, etc. The source driver circuit (224), may accept signals from a video processor, a main processor, or any other component (not shown) that provides image content to be displayed on the display screen (155). The source driver circuit (224) may receive the signals representing the image content in digital form and output analog signals to the transistors. Any kind of additional circuits related to the displaying images may be included in the source driver circuit (224), without departing from the disclosure.

In one or more embodiments, the sensing module (220) includes a multiplexer (MUX) circuit (226). The MUX circuit (226) is coupled to the sensing channel (205) and multiple sources. For example, the MUX circuit (226) may be coupled to the RX electrodes (236). The MUX circuit (226) may also be coupled to one or more of the TX electrodes (234), the source lines, and the gate lines (e.g., via wires, traces, etc.).

Although not shown in FIG. 2A, the MUX circuit (226) inputs a control signal. The MUX circuit (226) connects the sensing channel (205) to one of the sources (e.g., RX electrodes (236), TX electrodes (234), gate lines, and/or source lines), based on the control signal. The MUX circuit (226) relays a resulting signal (corresponding to absolute capacitance sensing or mutual capacitance sensing) from the selected source to the touch integrated circuit (IC) (210) via the sensing channel (205).

Those skilled in the art, having the benefit of this detailed description, will appreciate that the MUX circuit (226) reduces the number of the connections (e.g., wires, traces) needed from the sensing module (220) to the touch IC (210). A flexible printed circuit (not shown) may electrically interface the sensing module (220) with the touch sensing interface (250). The flexible printed circuit may provide limited surface area which may not be sufficient to accommodate all traces of all sensor electrodes. However, the flexible printed circuit may provide sufficient surface area to accommodate the reduced number of connections required for the sensing channel (205) and may further accommodate additional connections. Additional details are provided below.

The touch IC (210) may be configured to perform capacitance sensing. The touch IC (210) may drive electrodes (e.g., the TX electrodes (234) or a subset of the TX electrodes (234)), and may receive resulting signals from electrodes (e.g., from the RX electrodes (236) or a subset of the RX electrodes (236)) via the sensing channel (205), to determine the presence and/or position of an input object (e.g., input object (140), discussed above in reference to FIG. 1). In other words, the touch IC (210) may form an analog frontend for the capacitance sensing. The touch IC (210) may be disposed on a mainboard, a flexible printed circuit or elsewhere. An electric interface between the touch IC (210) and the MUX circuit (226) may be provided by a flexible connector accommodating conductive traces for the sensing channel (205) and other signals, described below.

Although FIG. 2A shows the input device (200) as having a single sensing module (220), in one or more embodiments, the input device (200) has multiple sensing modules. Further, although FIG. 2A shows the touch IC (210) coupled to a single sensing channel (205) and sensing module (220), in one or more embodiments, the IC (210) is coupled to multiple sensing channels and sensing modules.

In one or more embodiments, the touch IC (210) is a touch and display driver IC. In such embodiments, the touch IC (210) is configured to both perform capacitance sensing, as discussed above, and generate a display by driving the display circuitry, e.g., by providing input to the source driver (224).

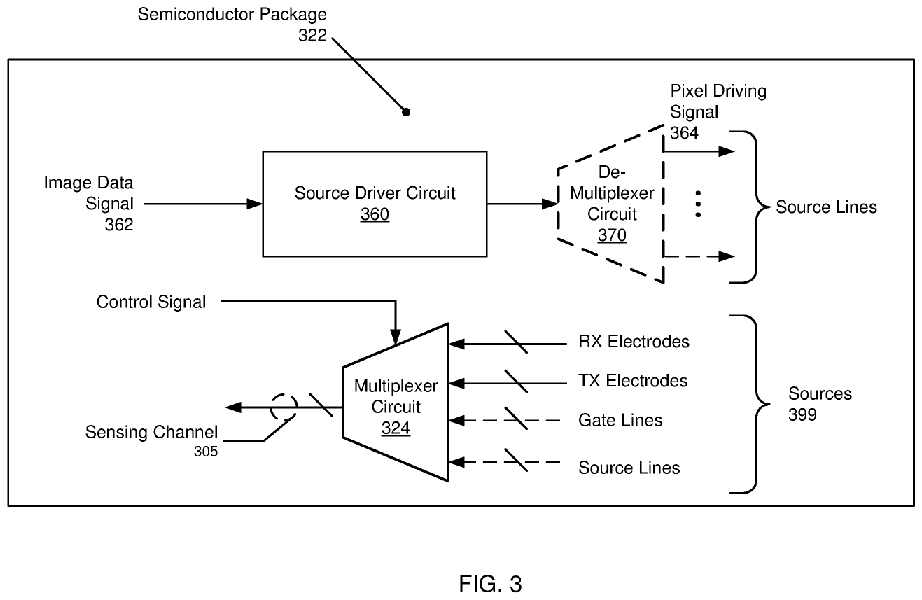

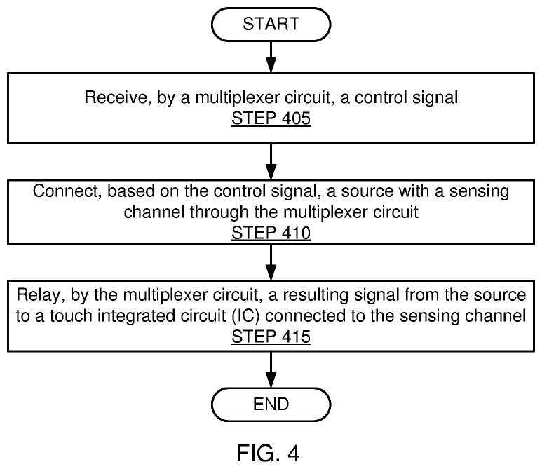

In one or more embodiments, the source driver circuit (224) and the MUX circuit (226) are integrated in a single semiconductor package (228), e.g., an application-specific integrated circuit (ASIC). The source driver circuit (224) and the MUX circuit (226) may be on separate dies or on a single die, in the semiconductor package (228). The semiconductor package (228), in one or more embodiments, is disposed on the display substrate (222). The combination of the source driver circuit (224) and the MUX circuit (226) in a single semiconductor package (228) may enable the placement of the MUX circuit (226) on the display substrate (222), despite limited available surface area. The semiconductor package (228) with the components integrated in the semiconductor package may form an interface module. The operation of the MUX circuits is described with reference to FIGS. 3 and 4.

FIG. 2B shows an input device (200) in accordance with one or more embodiments. As shown in FIG. 2B, the input device (200) includes a sensing module (220) coupled to a touch sensing interface (250). The sensing module (220) may be substantially similar to the sensing module (220) described in FIG. 2A, including the display substrate (222), the stack of display layers (230), the capacitive sensing layer(s) (232), including the TX electrodes (234) and/or RX electrodes (236). Further, the touch sensing interface (250) may be substantially similar to the touch sensing interface (250) described in FIG. 2A, including the touch ICs (210). However, unlike in FIG. 2A, in the embodiment shown in FIG. 2B, the semiconductor package (228) including the source driver (224) and the MUX circuit (226) is disposed on a flexible printed circuit (260). Accordingly, traces or wires from the sensor electrodes (e.g., the TX electrodes (234) and/or the RX electrodes (236)) extend onto the flexible printed circuit (260) to the MUX circuit (226) in the semiconductor package (228). The MUX circuit (226) may electrically interface with the touch sensing interface (250) via a sensing channel (205).

Turning to FIG. 2C, an input device (200), in accordance with one or more embodiments, is shown. In the example, the input device (200) includes an OLED display with OnCell touch sensor (280), with one or more of the touch sensing layers (TX electrodes and/or RX electrodes) disposed on top of the stack of display layers. Alternatively, the OLED display may be equipped with an InCell touch sensor with one or more of the touch sensing layers (TX electrodes and/or RX electrodes) disposed within the stack of display layers. The OLED display with OnCell sensor (280) is disposed on a chip on flex (COF) display substrate (290). The input device further includes a touch sensing interface (250) which may be located on a mainboard, interfacing with the COF film (290) either directly or via flexible connectors. As shown in FIG. 2B, the COF film (290) supports not only the OLED display with the OnCell sensor (280), but also six semiconductor packages (228), each housing a MUX circuit (226) and a source driver circuit (224). While available space on the COF film (290) may be limited, the MUX circuits (226) can be accommodated by jointly housing the MUX circuits (226) in semiconductor packages (228) along with the source driver circuits (224).

More specifically, consider the following configuration. The OnCell touch sensor may be a matrix pad sensor. The number of connections to sensor electrodes of the matrix pad sensor may exceed 1,000 connections. In the example, assume that the matrix pad sensor has 3,000 connections to sensor electrodes. Each of the MUX circuits (226) may receive 500 of the 3,000 connections. Assume that each of the MUX circuits implements a 6:1 multiplexing. Accordingly, the 3000 connections to sensor electrodes may be reduced to 500 touch connections from the MUX circuits (226) to the touch ICs (210), where charge measurements may be performed to detect touch. Each of the two touch ICs (210) may receive 250 touch connections. The six-fold reduction in required touch connections, in the example, is sufficient to accommodate the touch connections (solid connection between the MUX circuits (226) and the touch ICs (210)) and potentially any additional OLED display-related connections on the flexible connector to the two touch ICs (210) of the touch sensing interface (250).

To avoid or reduce interference with the analog touch signals, the MUX circuits may add no more than, for example, 100 Ohms of resistance and no more than a few picoFarads of capacitance to the pathway between a sensor electrode and a touch IC.

Further, additional connections for control signals lines (dashed connection between the MUX circuits (226) and the touch ICs (210)), described below, may be accommodated. The control signals may originate from one of the touch ICs (210), as shown in FIG. 2C, or reach of the touch ICs (210) may provide control signals to the corresponding MUX circuits (226).

While the above example describes a particular multiplexing ratio for a particular number of sensor electrodes, those skilled in the art will appreciate that any multiplexing ratio may be used for any number of sensing electrodes. Further, any number of semiconductor packages (228), housing a MUX circuit and a source driver circuit may be present.

FIG. 3 shows a semiconductor package (322) in accordance with one or more embodiments. The semiconductor package (322) may correspond to the semiconductor packages (228), discussed above with reference to FIGS. 2A, 2B, and 2C. A MUX circuit (324) is disposed on a die (not shown) in the semiconductor package (322). The MUX circuit (324) may correspond to the MUX circuit (226), discussed above in reference to FIGS. 2A, 2B, and 2C. As shown in FIG. 3, the MUX circuit (324) is coupled to multiple sources (399) and a sensing channel (305). The sources may include RX electrodes and/or TX electrodes. The sources may optionally include gate lines and/or source lines. Moreover, the MUX circuit (324) is operated by a control signal which selects one source of the sources (399) to connect to the sensing channel (305). The sensing channel (305) is coupled to a touch IC (not shown). A source driver circuit (360) is further disposed on a die (not shown) in the semiconductor package (322). The source driver circuit (360) may output a pixel driving signal to a demultiplexer circuit (370), which may forward the pixel driving signal to one of multiple source lines. Alternatively, the source driver circuit (360) may be coupled to a single source line. A single die may be shared between the source driver circuit (360), the demultiplexer circuit (370) and the MUX circuit (324), or separate dies may be used. The source driver may receive an image data signal (362) and may process the image data signal (362) to produce a pixel driving signal (364). The pixel driving signal (364) may include precise analog voltages for the pixels of the display screen to drive the pixels.

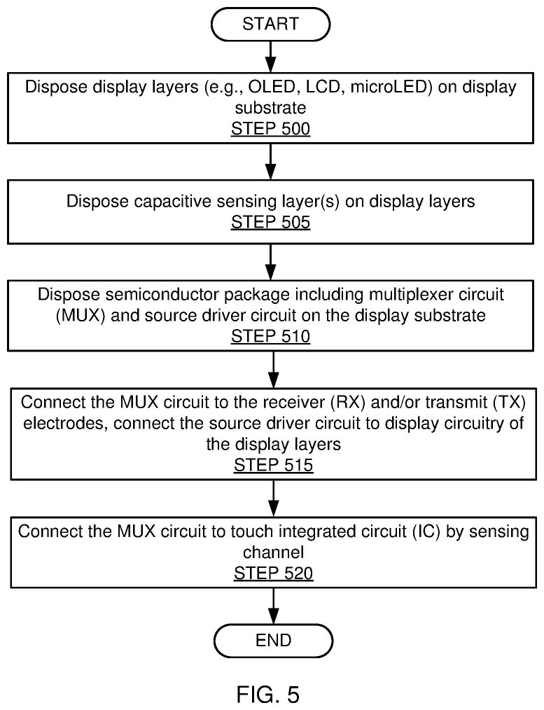

FIG. 4 and FIG. 5 show flowcharts in accordance with one or more embodiments. While the various steps in these flowcharts are presented and described sequentially, one of ordinary skill will appreciate that some or all of the steps may be executed in different orders, may be combined or omitted, and some or all of the steps may be executed in parallel. Additional steps may further be performed. Accordingly, the scope of the disclosure should not be considered limited to the specific arrangement of steps shown in FIG. 4 and FIG. 5.

Turning to FIG. 4, a flowchart in accordance with one or more embodiments is shown. The flowchart of FIG. 4 depicts a method for operating an input device. One or more of the steps in FIG. 4 may be performed by the components of the input device (200), discussed above in reference to FIGS. 2A, 2B, and 2C. In one or more embodiments, one or more of the steps shown in FIG. 4 may be omitted, repeated, and/or performed in a different order than the order shown in FIG. 4. Accordingly, embodiments should not be considered limited to the specific arrangement of steps shown in FIG. 4.

Initially, a control signal is received by a multiplexer (MUX) circuit (STEP 405). The control signal may be provided by a touch IC or a touch and display driver IC of the input device. Moreover, the MUX circuit may be a component in a sensing module of the input device and coupled to multiple sources. For example, the sources may include transmitter (TX) electrodes, receiver (RX) electrodes, source lines, and/or gate lines.

In STEP 410, the MUX circuit connects a source (e.g., a TX electrode, an RX electrode, a source line, a gate line, etc.) to a sensing channel based on the control signal. In other words, the control signal forces the MUX circuit to select one of the sources and connect the selected source to the sensing channel. The sensing channel is the data connection (e.g., wires, traces, etc.) between the touch IC or the touch and display driver IC and the MUX circuit.

In STEP 415, the MUX circuit relays a resulting signal from the selected source to the sensing channel. If an RX electrode is the selected source, the resulting signals is from the RX electrode while performing, for example, an absolute capacitance sensing. Additionally or alternatively, the resulting signal may be from an RX electrode while performing mutual capacitance sensing with the TX electrodes. If a TX electrode is the selected source, the resulting signal is from the transmitting electrode while executing absolute capacitance sensing. If a source line or gate line is the selected source, the resulting signal is from the source line or gate line, e.g., while performing an absolute capacitance sensing.

In one or more embodiments, the touch IC or touch and display driver IC may process the resulting signal to identify the presence and location of an input object touching or near the input device. In one or more embodiments, the process depicted in FIG. 4 may be repeated multiple times, and each time a different source may be selected. The resulting signal from one, two, or all of the sources may be used to determine the presence and location of an input object.

FIG. 5 shows a flowchart in accordance with one or more embodiments. The flowchart of FIG. 5 depicts a method of manufacturing an input device equipped with an OLED display screen. The result of executing the process of FIG. 5 may correspond to the input device depicted in any of FIG. 2A, FIG. 2B, and FIG. 2C.

In Step 500, display layers are disposed on the display substrate. Depending on the display type, the disposed display layers may differ.

In case of an OLED display screen, OLED layers are disposed on the display substrate to form a stack of display layers. The disposed layers may include an anode layer, an organic conductive layer, an organic emissive layer, and a cathode layer. The anode layer may include transistors, for an active OLED display screen. The display substrate may be flexible or rigid. Various materials, including but not limited to, plastic and glass may be used.

In case of an LCD display screen, LCD layers are disposed on the display substrate to form the stack of display layers. The disposed layers may include a TFT circuitry layer with transistors, a liquid crystal layer, and a color filter glass layer. The display substrate may be glass.

In case of a microLED screen, microLED layers are disposed on the display substrate to form the stack of display layers. The disposed layers may include a TFT circuitry layer and microLEDs disposed on the TFT circuitry layer. The display substrate may be flexible or rigid. Various materials, including but not limited to, plastic and glass may be used.

Other layers such as glass or film covers may be included, without departing from the disclosure.

In Step 505, one or more capacitive sensing layers are disposed on the stack of display layers. The capacitive sensing layers may include receiving (RX) and/or transmitting (TX) electrodes. One or more of the capacitive sensing layers may be in or on top of the stack of display layers.

In Step 510, a semiconductor package including a multiplexer (MUX) circuit, a source driver circuit, and optionally a demultiplexer (DEMUX) circuit is disposed on the display substrate. Alternatively, the semiconductor package may be disposed elsewhere, e.g., on a flexible printed circuit between the display substrate and a mainboard.

In STEP 515, the MUX circuit is coupled to the RX electrodes, TX electrodes, e.g., via a flexible printed circuit. The MUX circuit may also be coupled to circuitry of the display layers, e.g., gate lines and/or source lines of an active OLED, LCD, or microLED screen.

In STEP 520, the MUX circuit is coupled to a touch integrated circuit (IC) by a sensing channel. Other connections may be made, in addition. For example, a connection for a control signal may be established between the touch IC and the MUX circuit, and further connections for image signals to the source driver or the DEMUX circuit may be made.

Embodiments of the disclosure have one or more of the following advantages. By using the MUX circuit, the number of required electric connections (e.g., conductive traces) between the sensing module and the touch sensing interface is reduced. This may be beneficial when space is limited. For example, space on the display substrate adjacent to the stack of display layers, on the underside, and/or on an interfacing flexible printed circuit may be limited. By integrating the MUX circuit and the source driver circuit in a single semiconductor package, the limited available space may be used in an efficient manner. Embodiments of the disclosure may be implemented in conjunction with various display technologies including OLED, LCT, and microLED, on rigid or flexible substrates, using any type of touch sensing configuration.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An input device, comprising:
a flexible display substrate;
a stack of display layers and at least one capacitive sensing layer disposed on the flexible display substrate, the stack of display layers comprising a plurality of display pixels of a display screen;
a plurality of capacitive sensing electrodes disposed in the at least one capacitive sensing layer and configured for capacitance sensing;
a source driver circuit configured to drive at least a subset of the plurality of display pixels;
a multiplexer (MUX) circuit coupled to a plurality of sources and a sensing channel,
wherein the plurality of sources comprises at least a subset of the plurality of sensing electrodes, and
wherein the MUX circuit selectively couples one of the plurality of sources to the sensing channel based on a control signal; and
a semiconductor package disposed on the flexible display substrate, the semiconductor package enclosing the source driver circuit and the MUX circuit.

2. The input device of claim 1, further comprising:
a demultiplexer (DEMUX) circuit disposed between the source driver circuit and a plurality of source lines associated with the subset of the plurality of display pixels, and
wherein the semiconductor package encloses the DEMUX circuit.

3. The input device of claim 1, wherein the display screen is an organic light-emitting diode (OLED) display.

4. (canceled)

5. The input device of claim 1, wherein the flexible display substrate is a plastic substrate.

6. (canceled)

7. The input device of claim 1,
wherein the MUX circuit is coupled to a touch integrated circuit (IC) by a flexible printed circuit, and
wherein the touch IC provides an analog frontend configured to process signals of the subset of the plurality of sensing electrodes to determine a presence of an input object in a sensing region of the input device.

8. The input device of claim 1, further comprising:
a touch integrated circuit (IC) that is coupled to the sensing channel and configured to provide the control signal.

9. The input device of claim 8, wherein traces for the sensing channel and the control signal are routed on a flexible printed circuit between the touch IC and the MUX circuit.

10. The input device of claim 1, where the at least one capacitive sensing layer implements a matrix pad sensor.

11. A method for operating an input device, comprising:
receiving, by a multiplexer (MUX) circuit, a control signal,
wherein the MUX circuit is coupled to a sensing channel and a plurality of sources comprising a plurality of capacitive sensing electrodes, and
wherein a semiconductor package, disposed on a flexible printed circuit, encloses the MUX circuit and a source driver circuit, the source driver circuit configured to drive a plurality of display pixels of a display screen integrated in the input device;
coupling, by the MUX circuit and based on at least the control signal, the sensing channel with a source of the plurality of sources; and
relaying, by the MUX circuit, a resulting signal corresponding to capacitance sensing from the source to a touch integrated circuit (IC) coupled to the sensing channel.

12. The method of claim 11, wherein the display screen is an organic light-emitting diode (OLED) display.

13. The method of claim 11, wherein the display screen comprises a stack of display layers disposed on a display substrate.

14. The method of claim 13, wherein the display substrate is flexible.

15. The method of claim 13, wherein the display substrate is a plastic substrate.

16. (canceled)

17. The method of claim 11, wherein the control signal is provided by the touch IC.

18. An interface module, comprising:
a source driver circuit configured to drive a plurality of display pixels of a display screen; and
a multiplexer (MUX) circuit configured to couple to a plurality of sources configured for capacitive sensing of the display screen and a sensing channel, wherein the MUX circuit selectively couples one of the plurality of sources to the sensing channel based on a control signal; and
a semiconductor package disposed on a flexible printed circuit, the semiconductor package enclosing the source driver circuit and the MUX circuit.

19. The interface module of claim 18, further comprising:
a demultiplexer (DEMUX) circuit disposed between the source driver circuit and a plurality of source lines associated with the plurality of display pixels, and
wherein the semiconductor package encloses the DEMUX circuit.

20. (canceled)
